(19) United States
(12) Patent Application Publication
(10) Pub. No.: US 2026/0355886 A1
(43) Pub. Date: Nov. 12, 2026

(54) MORTISE AND TENON JIG

(71) Applicant: JessEm Tool Corporation, Moncton (CA)

(72) Inventors: Darrin A. Smith, Moncton (CA); Darrin E. Smith, Moncton (CA); Adam Vincent, Moncton (CA)

(21) Appl. No.: 19/201,409

(22) Filed: May 7, 2025

(51) Int. Cl. B23Q 9/00; B27F 5/02

(52) U.S. Cl. CPC B23Q 9/0014; B27F 5/02

(57) ABSTRACT

A mortise and/or tenon jig and associated components and methods for cutting a tenon and/or a mortise in a workpiece. The jig includes a guide assembly for locating and guiding a cutting element of a tool relative to the workpiece to cut the tenon and/or the mortise in the workpiece. The guide assembly includes a tenon template to be engaged and followed by the tool to cut the tenon in the workpiece. The tenon template is movable between first and second cutting positions to arrange the tenon template so the tool cuts different portions of the tenon in the workpiece as the tool engages and follows the tenon template. The guide assembly also includes a mortise template to be engaged and followed by the tool to cut the mortise in the workpiece. The tenon and mortise templates can be rotated to cut angled tenons and angled mortises.

### FIELD

The present invention generally relates to cutting jigs and more particularly to jigs for cutting mortises and tenons in workpieces.

### BACKGROUND

A mortise and tenon joint is a well-known connection used to connect two workpieces or members, frequently wooden members, together. The joint comprises two parts, one for each member of the connection: (1) a hole (such as a blind hole) or mortise in a first member and (2) a tenon in a second member sized and shaped to be inserted into the hole of the first member. The joint may be further secured with an adhesive (e.g., glue).

### SUMMARY

In one aspect, a jig for cutting a tenon in a workpiece using a tool having a cutting element generally comprises a guide assembly configured to locate and guide the cutting element of the tool relative to the workpiece to cut the tenon in the workpiece. The guide assembly comprises a guide base and a guide supported by the guide base. The guide includes a tenon template arranged to be engaged and followed by the tool to cut the tenon in the workpiece. The guide is movable relative to the guide base between a first cutting position in which the tenon template is arranged relative to the workpiece so that the tool cuts a portion of the tenon in the workpiece as the tool engages and follows the tenon template and a second cutting position in which the tenon template is arranged relative to the workpiece so that the tool cuts another portion of the tenon in the workpiece as the tool engages and follows the tenon template.

In another aspect, a jig for cutting a tenon or a mortise in a workpiece using a tool having a cutting element comprises a guide assembly configured to locate and guide the cutting element of the tool relative to the workpiece to cut the tenon or the mortise in the workpiece. The guide assembly comprises a template support including a template connector. A tenon template is configured to be engaged and followed by the tool to cut the tenon in the workpiece. The tenon template is releasably connectable to the template connector to configure the jig for cutting the tenon in the workpiece. A mortise template is configured to be engaged and followed by the tool to cut the mortise in the workpiece. The mortise template is releasably connectable to the template connector to configure the jig for cutting the mortise in the workpiece.

In another aspect, a jig for cutting a tenon or a mortise in a workpiece using a tool having a cutting element comprises a guide assembly configured to locate and guide the cutting element of the tool relative to the workpiece to cut the tenon or the mortise in the workpiece. The guide assembly comprises a guide base and a guide supported by the guide base. The guide includes a template arranged to be engaged and followed by the tool to cut the tenon or the mortise in the workpiece. The guide is rotatable relative to the guide base to change the orientation of the template relative to the workpiece to change the orientation of the tenon or the mortise cut in the workpiece. A retainer is configured to selectively inhibit the guide from rotating relative to the guide base to secure the orientation of the template relative to the workpiece.

Other objects and features will be in part apparent and in part pointed out hereinafter.

### BRIEF DESCRIPTION OF THE DRAWINGS

FIG. 1 is a perspective of a mortise and tenon assembly according to one embodiment of the present disclosure being used to form a mortise and/or a tenon in a workpiece;

FIG. 2 is a perspective of a mortise and tenon jig of the mortise and tenon assembly, the mortise and tenon jig configured to guide the cutting of the mortise in the workpiece;

FIG. 3 is a partial exploded view of the mortise and tenon jig;

FIG. 4 is a perspective of a support assembly of the mortise and tenon jig;

FIG. 5 is a perspective of a guide assembly of the mortise and tenon jig;

FIG. 6 is a bottom perspective of the guide assembly;

FIG. 7 is a partial exploded view of the guide assembly;

FIG. 8 is a perspective of a guide and a retainer of the guide assembly;

FIG. 9 is a longitudinal section of the guide and the retainer of FIG. 8;

FIG. 10 is a partial exploded view of the guide;

FIG. 11 is a bottom perspective of the guide, with a template removed;

FIG. 12 is a perspective of a mortise template of the mortise and tenon jig;

FIG. 13 is a perspective of a tenon template of the mortise and tenon jig;

FIG. 14A illustrates the mortise and tenon jig configured to cut the tenon in the workpiece, the guide being in a first cutting position;

FIG. 14B is the same as FIG. 14A with the guide in a second cutting position;

FIG. 15A illustrates the mortise and tenon jig configured to cut the mortise in the workpiece at an angled orientation;

FIG. 15B illustrates the mortise and tenon jig configured to cut the tenon in the workpiece at an angled orientation, the guide being in a first cutting position;

FIG. 15C is the same as FIG. 15B with the guide in the second cutting position; and

FIG. 16 is a perspective of a tool of the mortise and tenon assembly used to cut the mortise and the tenon in the workpiece using the mortise and tenon jig.

Corresponding reference characters indicate corresponding parts throughout the drawings.

### DETAILED DESCRIPTION

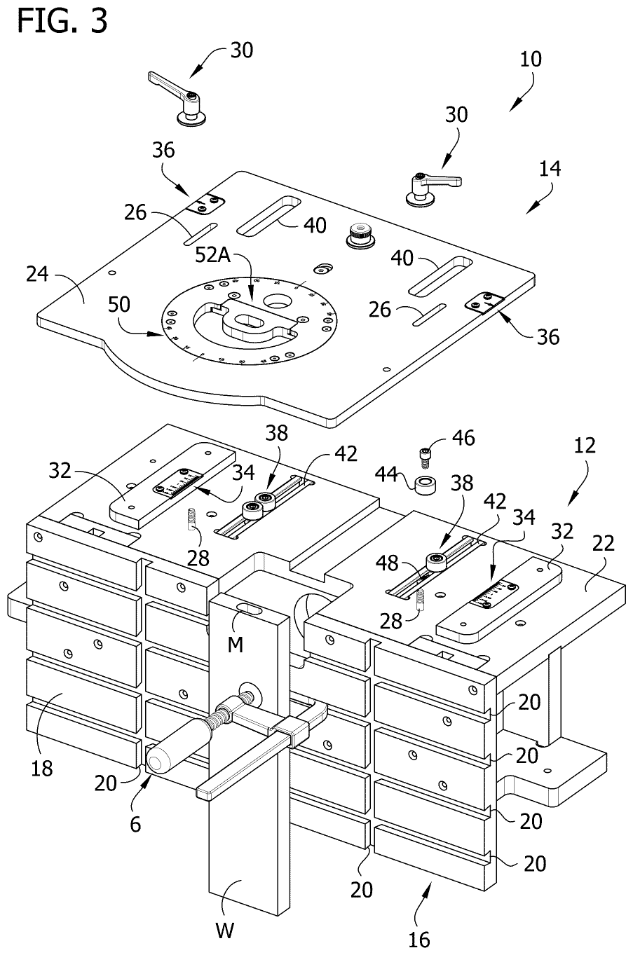

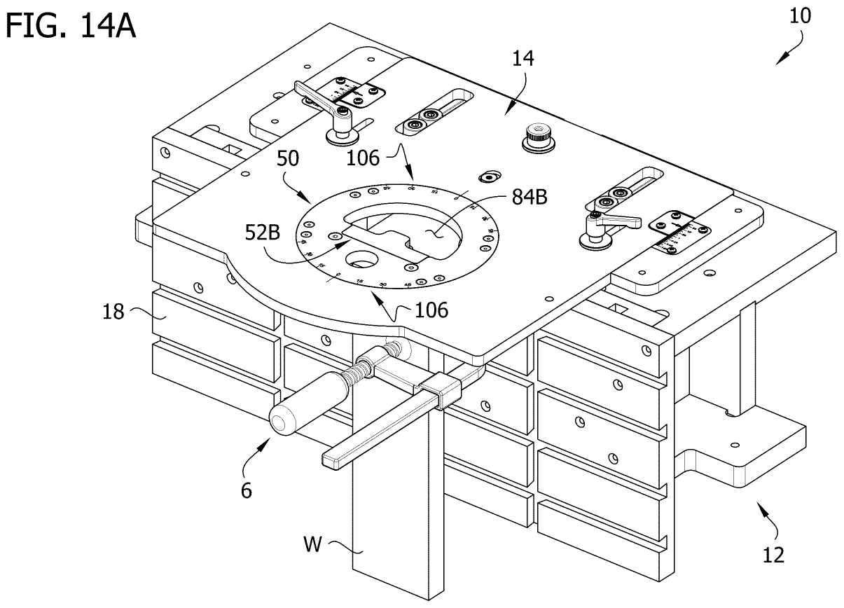

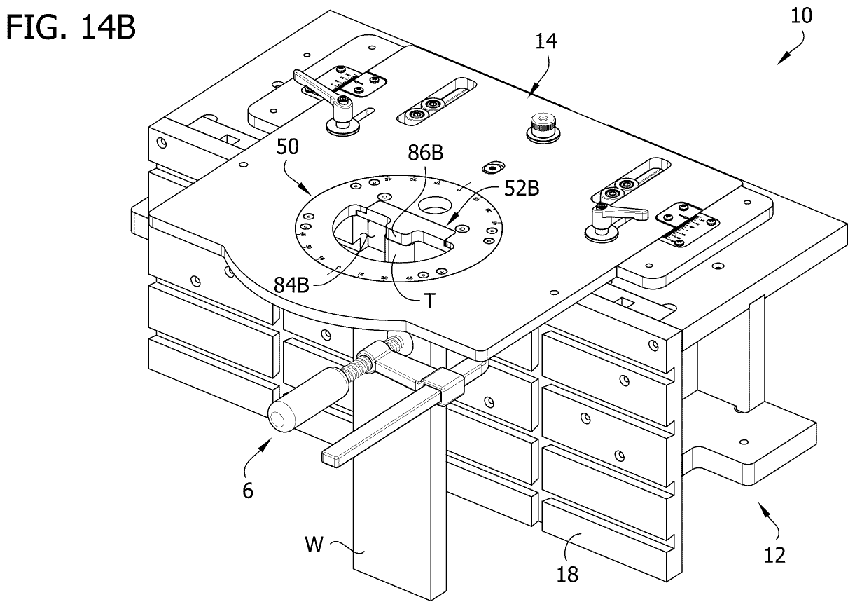

The present disclosure relates to a mortise and/or tenon mill or jig for creating a mortise M (FIG. 3) and/or a tenon T (FIG. 14B) of a mortise and tenon joint in a workpiece W (e.g., at an end or edge thereof). The workpiece W can be, for example, a wooden member (e.g., a piece of lumber). For example, the jig can be used to create the mortise M in a first workpiece W and the tenon T in a second workpiece. After, the tenon T is inserted into the mortise M to form the mortise and tenon joint connecting the two workpieces W together.

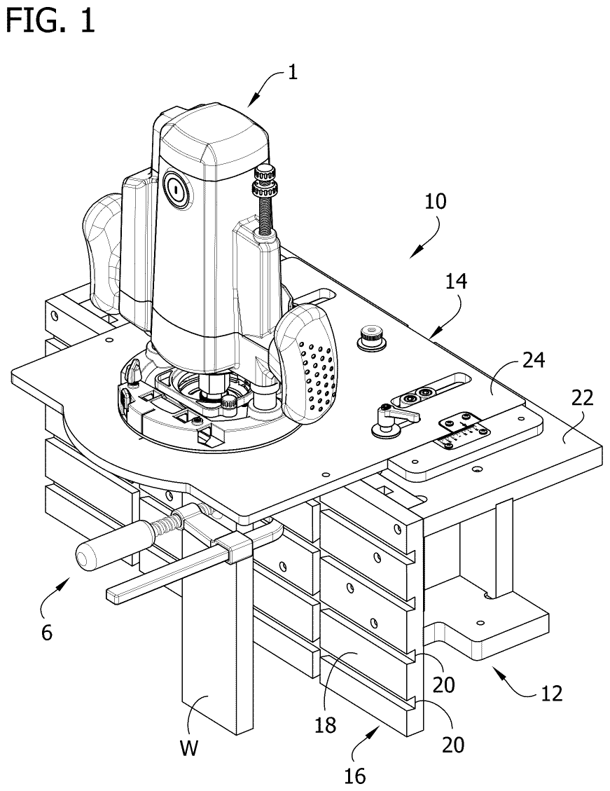

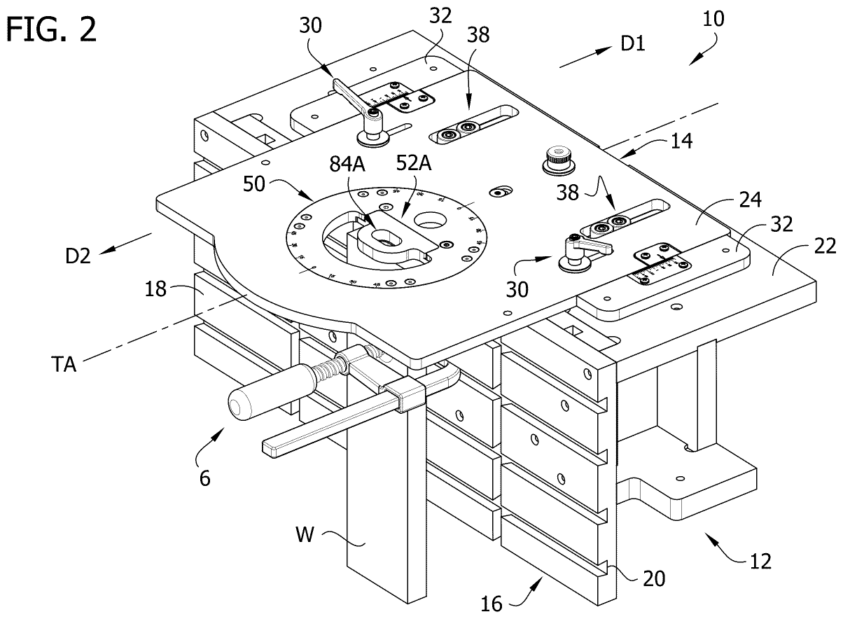

Referring now to the drawings and in particular to FIGS. 1-3, a mortise and tenon mill or mortise and tenon jig (hereinafter “jig”) according to one embodiment of the present disclosure is generally indicated at reference numeral 10. The jig 10 can be configured or set-up to cut a mortise M in the workpiece W (e.g., a mortise configuration (FIG. 2)) and a tenon T in the workpiece (e.g., a tenon configuration (FIGS. 14A-B)). Thus, the mortise and tenon jig 10 may also be referred to as a mortise or mortising jig or as a tenon or tenoning jig. The jig 10 is used for cutting the mortise M and/or the tenon T in a workpiece W. The jig 10 is used with a tool 1 (e.g., power tool), such as a router (e.g., plunge router) shown in the figures, or other suitable, well-known tools. The router 1 has a cutting element 2, such as a drill or router bit, which cuts the mortise M or tenon T in the workpiece W as the cutting element is rotated by the router. The jig 10 is of the type primarily used for wood working. However, it is envisioned that other materials can be worked by this apparatus. As will become apparent, the jig 10 receives and guides the cutting element 2 of the router 1 during the operation of the jig to cut the mortise M and/or the tenon T in the workpiece W.

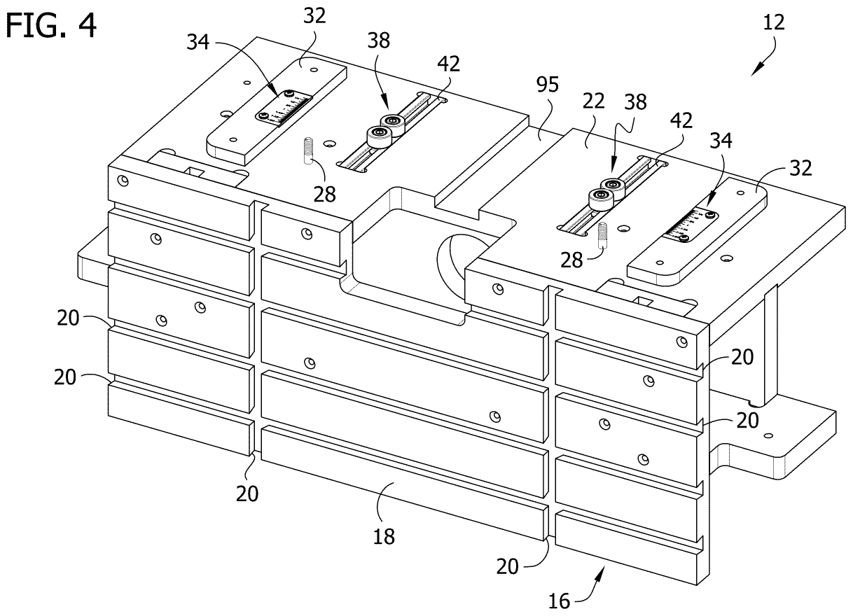

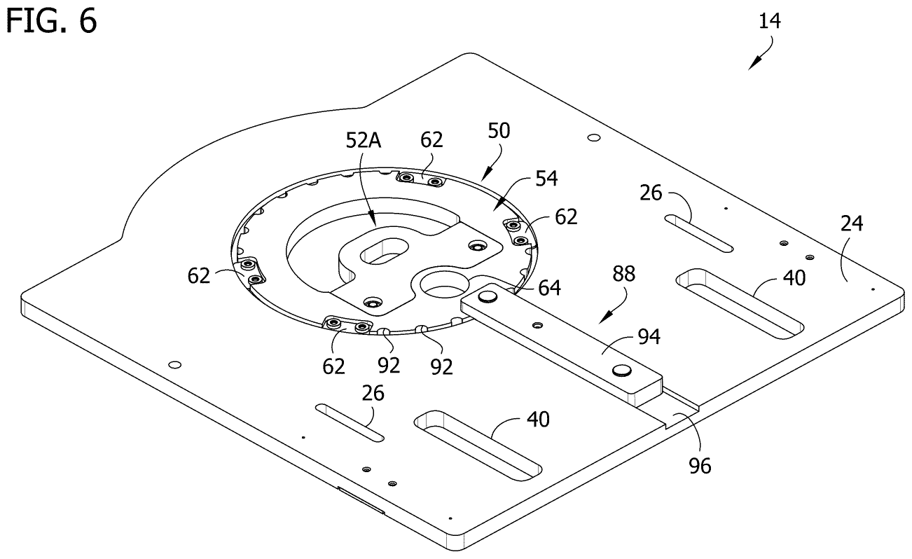

Referring to FIGS. 1-6, the jig 10 includes a base or support assembly 12 and a guide assembly 14. The support assembly 12 includes a woodworking fence 16 (as generally known in the art) having a front face 18 with one or more channels 20 therein for connecting accessories 6, such as the illustrated clamp, to the fence 16. The front face 18 lies in a reference plane. The clamp 6 is used to secure the workpiece W to the front face 4 of the fence 16 during operation of the jig 10, although other ways of securing the workpiece may be used without departing from the scope of the present disclosure. The support assembly 12 may be secured to a tabletop or bench top, such as by one or more fasteners. The support assembly 12 includes a platform or upper wall 22 that supports the guide assembly 14.

The guide assembly 14 locates and guides the cutting element 2 of the router 1 relative to the workpiece W to cut the tenon T and/or mortise M in the workpiece. The guide assembly 14 is supported by (e.g., rests on) and is movably (e.g., slideably) attached to the support assembly 12, specifically the platform 22. The guide assembly 14 includes a guide base or plate 24. The guide base 24 is connected to the support assembly 12. The guide base 24 rests and slides on the platform 22 (e.g., the upper surface thereof). The guide base 24 moves along a travel axis TA that is generally perpendicular to the reference plane (e.g., moves in a direction generally perpendicular to the reference plane). This sets the distance of the cutting element 2 of the router 1 relative to the front face 18 (e.g., reference plane), which in turn sets the position of the tenon T and/or mortise M to be formed in the workpiece W relative to the front face 18 of the fence 16. The guide base 24 includes one or more connection slots 26 (extending parallel to the travel axis TA), through which a stud or shaft 28 (e.g., threaded stud) of the support assembly 12 extends. The support assembly 12 includes at least one base retainer or clamp 30 for releasably securing the guide assembly 14 (specifically, the guide base 24) in position relative to the support assembly 12. Each base retainer 30 is threadably connected to one of the studs 28. Tightening the base retainers 30 against the guide base 24 secures (e.g., fixes) the position of the guide base (broadly, the guide assembly 14) relative to the support assembly 12 (e.g., the reference plane). Loosening the base retainers 30 from the guide base 24 permits the guide base (broadly, the guide assembly 14) to move relative to the support assembly 12 along the travel axis TA.

The support assembly 12 includes guides or guide blocks 32 on either side of the guide base 24 for guiding the movement of the guide base along the travel axis TA. The guide blocks 32 engage opposite sides (e.g., edges) of the guide base 24. One of the guide blocks 32 and the guide assembly 14 may include position indicia 34 (e.g., ruler markings such as 0-inch, ¼-inch, ½-inch, etc.) and the other of the guide blocks and the guide assembly may include a position indicator 36 (e.g., an arrow) that aligns with one of the marks (e.g., ¾-inch) of the position indicia 34 for informing the user of the distance between the tenon T and/or mortise M that will be cut in the workpiece W and the reference plane (e.g., the distance between the cutting element 2 and the front face 18 of the fence 16). The distance may be from the center of the tenon T and/or mortise M, although other distances such as between the side closest to the reference plane can be indicated. In the illustrated embodiment, the position indicia 34 is on the guide blocks 32 and the position indicator 36 is on the guide base 24, although the opposite arrangement can also be used without departing from the scope of the present disclosure.

The support assembly 12 may also include travel limiters or stops 38 for setting or limiting the distance the guide assembly 14 can move along the travel axis TA relative to the reference plane. This is useful when wanting to move the guide assembly 14 repeatedly between different positions for different cuts (e.g., different distances of the tenon T and/or mortise M from the reference plane). The stops 38 are arranged to engage the guide assembly 14 (specifically, the guide base 24) to limit the movement of the guide assembly relative to the support assembly 12. In the illustrated embodiment, the guide base 24 includes two travel slots 40 (extending parallel to the travel axis TA) in which stops 38 are positioned. The stop 38 engages one or both ends of the travel slot 40 to inhibit further movement of the guide base 24 relative to the support assembly 12. In the illustrated embodiment, there are two stops 38 in each travel slot 40, a forward stop and a rearward stop. The forward stop 38 is positioned to engage the front end of the travel slot 40 for limiting the rearward movement D1 (FIG. 2) of the guide base 24 along the travel axis TA, thereby setting a minimum distance between the tenon T and/or mortise M and the reference plane. The rearward stop 38 is positioned to engage the rear end of the travel slot 40 for limiting the forward movement D2 (FIG. 2) of the guide base 24 along the travel axis TA, thereby, setting a maximum distance between the tenon T and/or mortise M and the reference plane. The stops 38 are movably connected to a channel 42 (extending parallel to the travel axis TA) in the platform 22 of the support base 12. Each stop 38 can be releasably fixed along the channel 42 to set the minimum and maximum distances. In the illustrated embodiment (FIG. 3), each stop 38 comprises a bearing or bushing 44 (broadly, collar), a fastener 46 extending through the bearing 44, and a nut 48 (e.g., T-nut) threadably connected to the fastener and disposed in the channel 42. The bearing 44 is disposed in the travel slot 40 for engaging the guide base 24. Tightening the fastener 46 secures the position of the stop 38 along the channel 42 (e.g., clamps the nut 48 against the channel). Loosening the fastener 46 permits the stop 38 to move along the channel 42. Other configurations and numbers of the stops may be used without departing from the scope of the present disclosure.

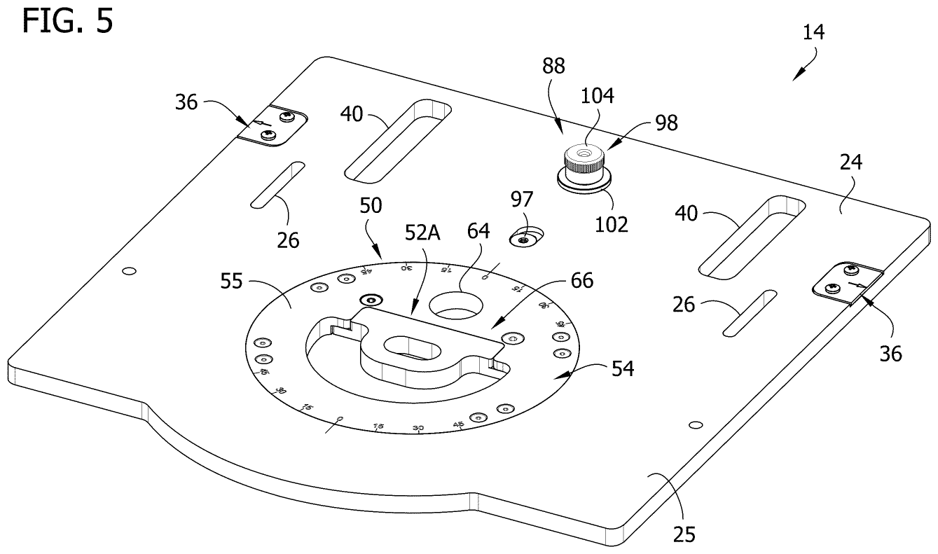

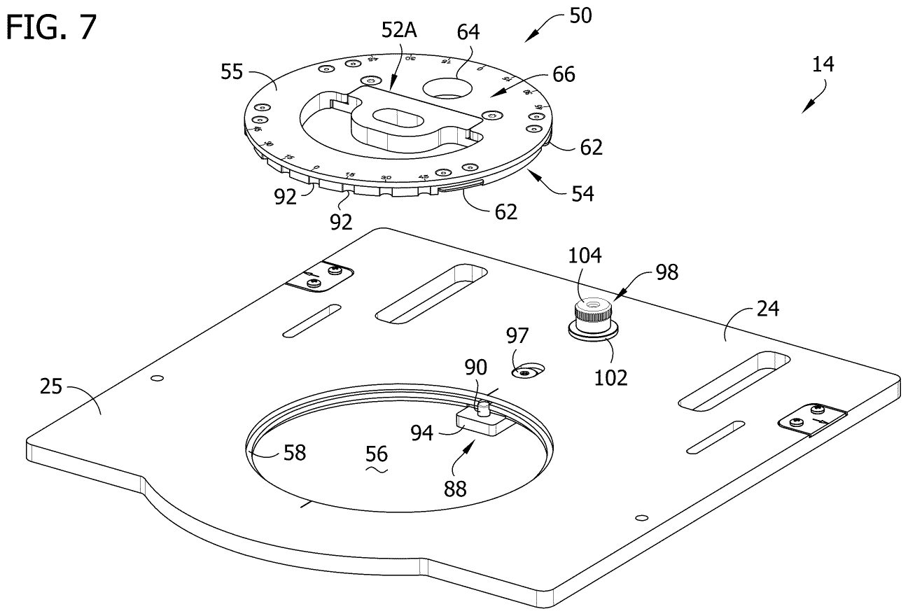

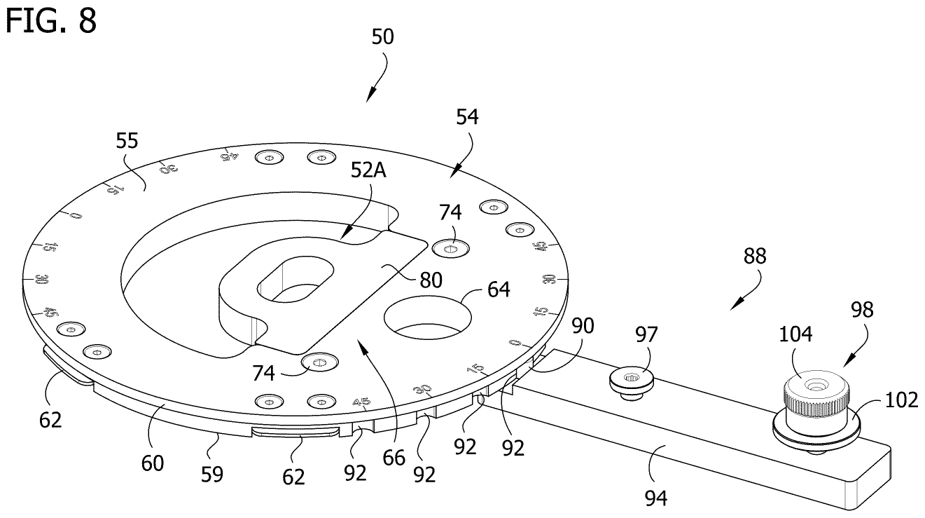

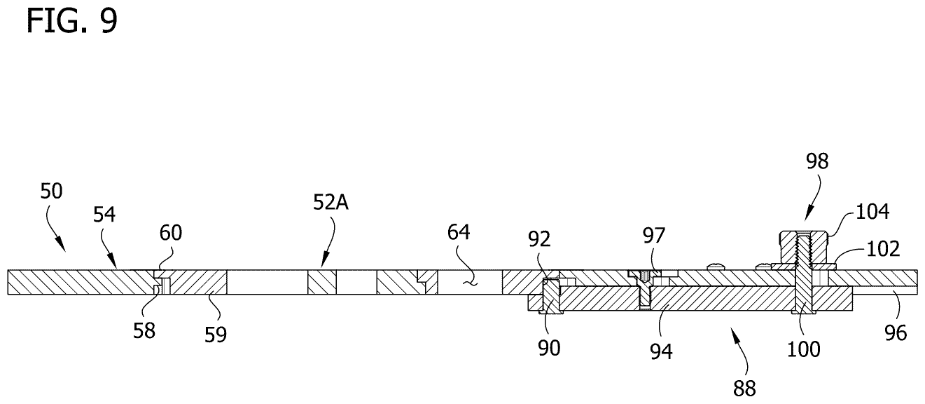

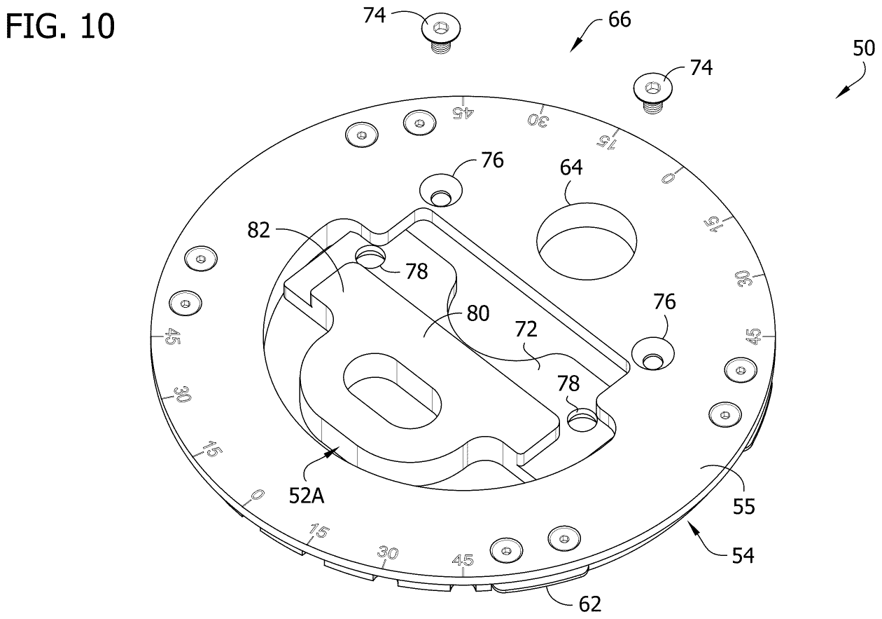

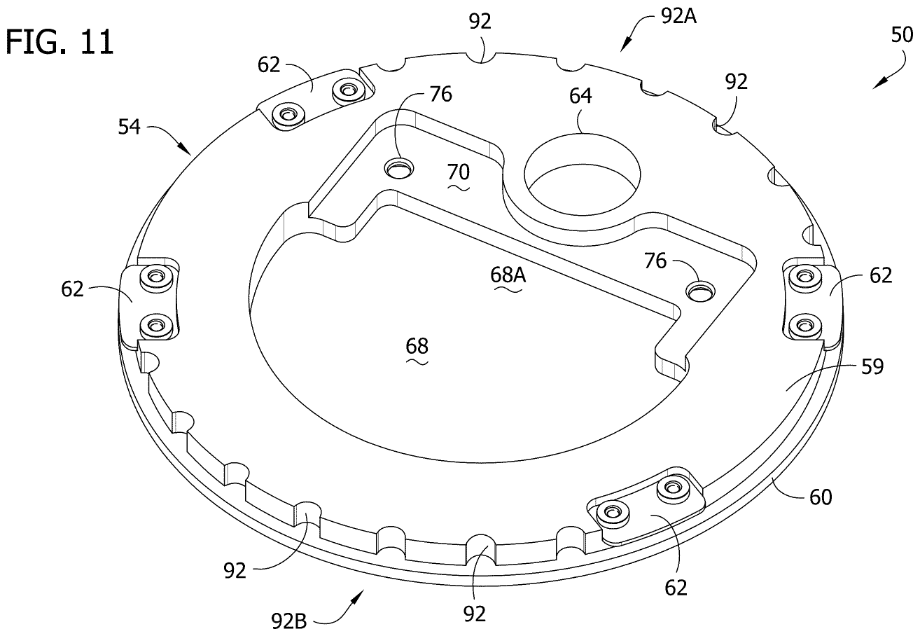

Referring to FIGS. 5-13, the guide assembly 14 includes a cutting guide 50 (broadly, guide) for guiding the cutting element 2 of the router 1 relataive to the workpiece W to cut the tenon T and/or mortise M in the workpiece. The cutting guide 50 is supported (e.g., carried) by the guide base 24. The cutting guide 50 is slidingly movable, specifically rotatable, relative to the guide base to a plurality of different positions (e.g., cutting position). In the illustrated embodiment, the cutting guide 50 is slidably mounted on the guide base 24. The cutting guide 50 includes a template support 54. The cutting guide 50 movably (e.g., rotatably) connects the template support 54 to the guide base 24. In the illustrated embodiment, the guide base 24 includes a guide base opening 56 (FIG. 7) in which the cutting guide 50 (specifically, the template support 54) is disposed in. The guide base opening 56 is circular in shape. The cutting guide 50, specifically the template support 54, is rotatable in the guide base opening 56. To connect the template support 54 to the guide base 24, the guide base includes a circumferential inner flange 58 extending radially inward into the guide base opening 56. The template support 54 is generally a circular disk or plate with a circular body 59 and a circumferential upper flange 60 extending radially outward from the circular body that overlaps and rests on the inner flange 58 of the guide base 24 (FIG. 9). The engagement of the upper flange 60 with the upper surface of the inner flange 58 prevents the template support 54 from falling down through the guide base opening 56. The template support 54 includes one or more securing tabs or flanges 62 that also extend radially outward from the circular body 59 to underlie the inner flange 58 of the guide base 24 (FIG. 11). The engagement of the securing tabs 62 with the bottom surface of the inner flange 58 prevents the template support 54 from lifting or moving upward out of the guide base opening 56. The securing tabs 62 are spaced apart from the upper flange 60, thereby forming a recess sized and shaped to receive the inner flange 58 and permit the template support 54 (broadly, the cutting guide 50) to rotate within the guide base opening 56. In movement, the lower surface of the upper flange 60 slides over the upper surface of the inner flange 58. The axis of rotation the template support 54 rotates about extends through the center of the guide base opening 56, and is generally parallel to the reference plane. In the illustrated embodiment, each securing tab 62 is connected to the circular body 59 with one or more fasteners (and nuts), although other ways can be used without departing from the scope of the present disclosure. Other ways of connecting the cutting guide 50 to the guide base 24 can be used without departing from the scope of the present disclosure.

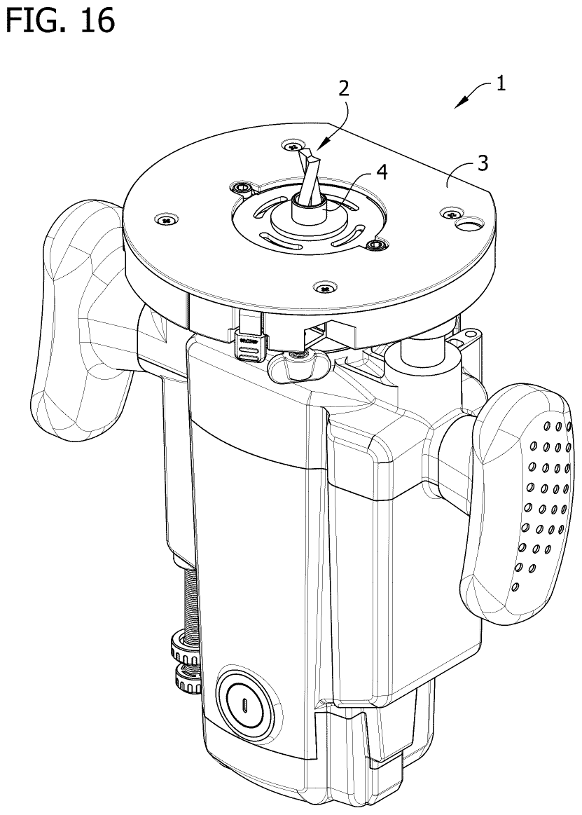

The template support 54 has an upper or tool support surface 55 that is generally coplanar with the upper or tool support surface 25 of the guide base 24. The tool support surfaces 55, 25 of the template support 54 and the guide base 24 are engaged by and support the router 1 as the router cuts the tenon T or mortise M in the workpiece W. The router 1 includes a support base 3 (FIG. 16) with a bottom surface that rests on and slides over the tool support surfaces 55, 25 when cutting the workpiece W. Any fasteners of the template support 54 are flush with or recessed in the tool support surface 55 of the template support, so as to not interfere with the sliding of the support base 3 of the router 1 over the tool support surface. The template support 54 can also include a finger opening 64 sized and shaped to receive a finger of the user to allow the user to rotate the cutting guide 54 relative to the guide base 24. The template support 54 also includes a template support opening 68 in the circular body 59. The axis of rotation extends through the template support opening 68.

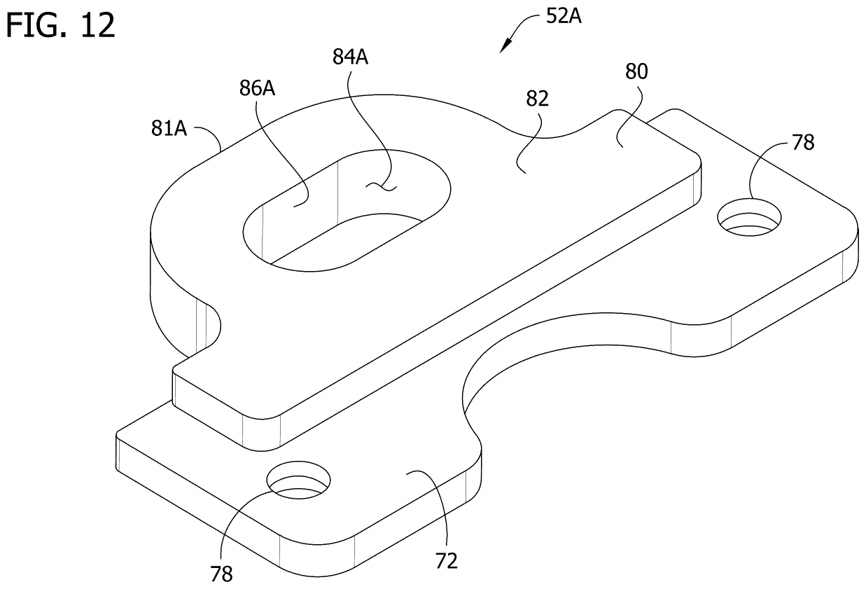

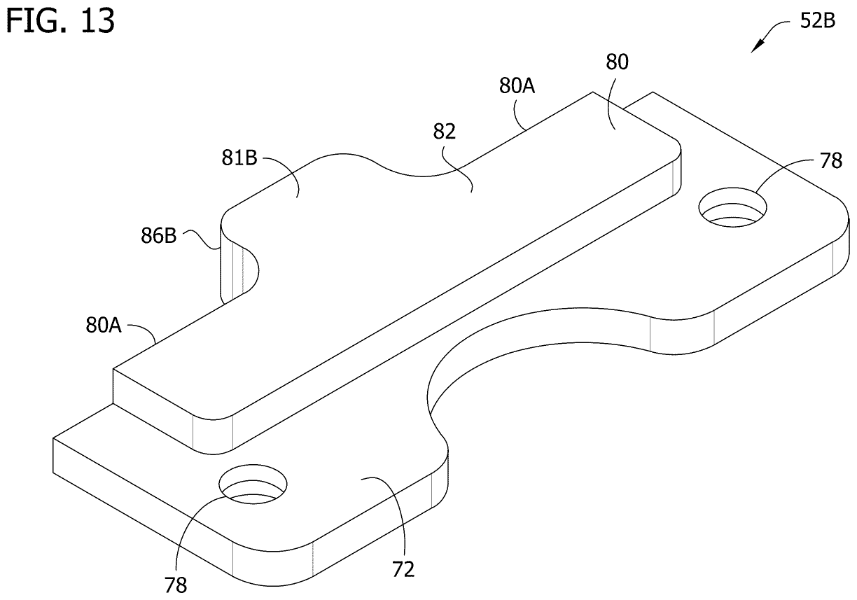

The cutting guide 50 (broadly, the jig 10) includes at least one template to be engaged and followed by the router 1 to cut the tenon T or the mortise M in the workpiece W. Desirably, the cutting guide 50 includes a mortise template 52A (FIG. 12) configured to be engaged and followed by the router 1 to cut the mortise M in the workpiece W and a tenon template 52B (FIG. 13) configured to be engaged and followed by the router to cut the tenon T in the workpiece. In one embodiment, the cutting guide 50 (broadly, the jig) may include a plurality of tenon templates for cutting tenons of different lengths and/or widths and/or a plurality of mortise templates for cutting mortises of different lengths and/or widths. This allows a user to select the template according to their desired size of tenon T and/or mortise M.

The template support 54 includes a template connector 66. Each template 52A, 52B is releasably connectable to the template connector 66 for connecting the template to the template support 54. This allows the user to configure the cutting guide 50 (broadly, the jig 10) to cut the tenon T in the workpiece W or the mortise M in the workpiece by selecting the desired template 52A, 52B. If the user wants to cut the tenon T in the workpiece W, the user configures the jig 10 for cutting the tenon by connecting the tenon template 52B to the template support 54. If the user wants to cut the mortise M in the workpiece W, the user configures the jig 10 for cutting the mortise by connecting the mortise template 52A to the template support 54. In the illustrated embodiment, template connector 66 includes a template recess 70 (FIG. 11) in the template support 54 on the underside or bottom of the circular body 59. The template recess 70 is in communication with (e.g., borders) the template support opening 68. The template recess 70 is sized and shaped to receive a portion of the template 52A, 52B when the template is connected to the template connector 66. In particular, the template recess 70 is sized and shaped to receive a connecting flange 72 of the template 52A, 52B. Desirably, the shape of the perimeter of the connecting flange 72 matches the shape of the perimeter of the template recess 70 formed by the circular body 59 to that the perimeter (e.g., a majority thereof) of the connecting flange engages the circular body to position the template 52A, 52B relative to the template support 54 and brace the template against moving relative to the template support, such as when the router 1 is cutting the workpiece W.

The template connector 66 also includes one or more template retainers 74 that secure the template 52A, 52B to the template connector 66 (broadly, the template support 54) when the template is connected to the template connector. Each illustrated template retainer 74 comprises a threaded fastener that extends through a corresponding fastener opening 76 in the template support 54 (e.g., circular body 59) and into an internally threaded opening 78 in the connecting flange 72 of the template 52A, 52B. The template 52A, 52B can include a central body or key portion 80 that is sized and shaped to fit into a key section 68A of the template support opening 68. The connecting flange 72 extends outward form the key portion 80. The shape of the perimeter of the key portion 80 matches the shape of the perimeter of the key section 68A formed by the circular body 59 to that the perimeter (e.g., a majority thereof) of the key portion engages the circular body to position the template 52A, 52B relative to the template support 54 and further brace the template against moving relative to the template support, such as when the router 1 is cutting the workpiece W. Other ways of connecting the template to the template support can be used without departing from the scope of the present disclosure.

To disconnect the template 52A, 52B from the template connector 66, the user removes the template retainers 74 from engagement with the template, specifically the connecting flange 72 (e.g., unscrews the fasteners from the threaded openings 78). The user then moves the template 52A, 52B out of the template support opening 68, such as by sliding the template out of the template recess 70 and lifting the template out of the template support opening. To connect the template 52A, 52B to the template connector 66, the user positions the template in the template support opening 68 and slides the template (e.g., the connecting flange 72) into the template recess 70. The user then engages the template retainers 74 with the template 52A, 52B, specifically the connecting flange 72 (e.g., screws the fasteners into the threaded openings 78).

The template 52A, 52B includes an upper or tool support surface 82 (e.g., a mortise template tool support surface of the mortise template, and a tenon template tool support surface of the tenon template). The tool support surface 82 of the template 52A, 52B is generally coplanar with the tool support surface 55 of the template support 54 (and tool support surface 25 of the guide base 24) when template is connected to the template support. The tool support surface 82 of the template 52A, 52B also is engaged by and supports the router 1 (e.g., the support base 3) as the router cuts the tenon T or the mortise M in the workpiece W. The template 52A, 52B can be a single, integrally formed piece as shown, or made of multiple pieces connected together, such as by fasteners or welding. The template 52A, 52B can be made of metal, such as aluminum or steel, or any other suitable material. Preferably, the templates 52A, 53B are configured such that the tenon T and the mortise M will each be cut at the same distance from the reference plane when the templates are connected to the template support 54 (without having to move the guide base 24).

The cutting guide 50 defines a cutting opening sized and shaped to permit the cutting element 2 of the router 1 to be inserted through the cutting opeing to cut the tenon T or the mortise M in the workpiece W. The configuration of the cutting opening depends on which template 52A, 52B is connected to the template support 54. With reference to FIG. 12, the mortise template 52A defines the entirety of the cutting window 84A (e.g., mortise cutting window) for cutting the mortise M in the workpiece W. The cutting window 84A is a slot. When connected to the template support 54, the cutting window 84A is disposed in the template support opening 68 (e.g., is a portion thereof). The mortise template 52A has a mortise template cutting edge 86A that bounds (e.g., entirely bounds) the cutting window 84A. A U-shaped projection 81A extends from the key portion 80 and together with the key portion forms the mortise template cutting edge 86A. The mortise template cutting edge 86A is shaped such that the cutting element 2 cuts the mortise M in the workpiece W as the router 1 (e.g., bushing 4 thereof) moves in engagement with and along the mortise template cutting edge. In other words, the shape of the mortise template cutting edge 86A matches the shape of the mortise M that will be cut. When the mortise template 52A is connected to the template support 54, the axis of rotation of the cutting guide 50 extends through the center of the cutting window 84A. In other words, the axis of rotation will extend through the center of the cut mortise M in the workpiece W.

With reference to FIGS. 1 and 2, to cut the mortise M in the workpiece W, the jig 10 is configured in the mortise configuration by connecting the mortise template 52A to the template support 54. The user positions the workpiece W and the cutting window 84B (broadly, guide assembly 14) relative to one another so that the mortise M will be cut at the desired location. The user secures the workpiece against the front face 18 of the fence 16 with one or more clamps 6. The user may also move the guide assembly 14 in the forward direction D2 or rearward direction D1 to move the cutting window 84B relative to the workpeice W. The router 1 includes a bushing 4 connected to the support base 3 of the router and through which the cutting element 2 extends (FIG. 16). To cut the mortise M in the workpiece W, the user inserts the bushing 4 of the router 1 into the cutting window 84B (with the support base 3 of the tool resting on one or more of the tool support surfaces 25, 55, 82). After, the user can operate the router 1 to rotate the cutting element 2 and move the cutting element downward through the bushing 4 and into the workpiece W to begin cutting the mortise M (as known in the art, a plunge router allows the cutting element to move vertically relative to the support base, so the cutting element can start and stop rotating when spaced apart from the workpiece). The user moves the router 1 within the cutting window 84B to cut the mortise M. For example, the user may keep the bushing 4 in engagement with the mortise template cutting edge 86A and slide the bushing along the mortise template cutting edge to trace the entire perimeter of the cutting window 84B. The user may move the router 1 in other ways such as back-and-forth and/or side-to-side in the cutting window 84B to cut the mortise M in the workpiece W. After the user has moved the cutting element 2 over the entire area of the cutting window 84B, the user withdraws the cutting element from the cutting window, thereby leaving the finished mortise M in the workpiece W.

With reference to FIGS. 13-14B, the tenon template 52B defines a portion (broadly, at least a portion) of the cutting window 84B (e.g., tenon cutting window) for cutting the tenon T in the workpiece W. The cutting window 84B has a generally half-circle shape. When connected to the template support 54, the cutting window 84B is disposed in the template support opening 68 (e.g., is a portion thereof), specifically is the portion of the template support opening that is not occupied by the tenon template 52B. The tenon template 52B has a tenon template cutting edge 86B that bounds a portion of the cutting window 84B. A generally rectangular tab 81B projects from the key portion 80. The exposed perimeter (e.g., three edge sections) of the rectangular body 81B forms the tenon template cutting edge 86B. The exposed corners of the rectangular body 81B are rounded so that the ends of the tenon T cut in the workpiece W will be rounded to match the rounded ends of the mortise M cut by the jig 10 in another workpiece W. The key portion 80 has exposed edges 80A on either side of the rectangular body 81B that are coplanar with one another and also bound a portion of the cutting window 84B. The tenon template cutting edge 86B is shaped such that the cutting element 2 cuts the tenon T in the workpiece W as the router 1 moves in engagement with and along the tenon template cutting edge. In other words, the shape of the tenon template cutting edge 86B matches the shape of the tenon T that will be cut.

In the illustrated embodiment, the tenon template 52B, specifically the tenon template cutting edge 86B, is configured to guide the cutting element 2 of the router 1 to cut only a portion of the tenon T in the workpiece W at a time (e.g., during a single cut or cutting operation of the router). The movability (e.g., rotatabilty) of the cutting guide 50 (e.g., the template support 54) relative to the guide base 24 allows the tenon template 52B to be positioned in different orientations or positions relative to the workpiece W to cut the entire tenon T in the workpiece W, by using the router 1 to make multiple (e.g., two) cuts (a cut in each position the tenon template is moved to). The cutting guide 50 moves relative to the guide base 24 between a first cutting position (FIG. 14A) and a second cutting position (FIG. 14B), to move the tenon template 52B (when connected to the template support 54) between the first and second cutting positions. In the first cutting position (FIG. 14A), the tenon template 52B is arranged relative to the workpiece W so that the router 1 cuts a first portion of the tenon T in the workpiece as the router engages and follows the tenon template. In the second cutting position (FIG. 14B), the tenon template 52B is arranged relative to the workpiece W so that the router 1 cuts a second portion (e.g., the remaining portion) of the tenon T in the workpiece as the router engages and follows the tenon template.

In the illustrated embodiment, the tenon template 52B is configured so that the entire tenon T can be cut into the workpiece W by just two cuts or cutting operations of the router 1, one in each cutting position. In other words, the entire tenon T can be cut in the workpeice W with only positioning the cutting template 52B in the first and second cutting positions (and making a cut in each position with the router 1). The tenon template 52B, specifically the tenon template cutting edge 86B, is configured so that the cutting element 2 cuts approximately half the tenon T in each of the first and second cutting positions. In the first cutting position (FIG. 14A), the tenon template 52B is arranged relative to the workpeice W so that the router 1 cuts approximately half of the tenon T (e.g., one long side of the tenon and about half of each end of the tenon) in the workpiece as the router engages and follows the tenon template. In the second cutting position (FIG. 14B), the tenon template 52B is arranged relative to the workpiece W so that the router 1 cuts the remaining portion (e.g., the remaining approximate half) of the tenon T (e.g., the other long side of the tenon and the remaining halfs of each end of the tenon) in the workpiece as the router (e.g., bushing 4) engages and follows the tenon template. FIG. 14B shows the finished tenon T after a cut has been made by the router 1 with the tenon template 52B in the second cutting position. It is understood that the first and second cutting positions can be reversed—e.g., FIG. 14A shows the second cutting position and FIG. 14B shows the first cutting position. It does not matter which cutting position the user starts with to cut the tenon T. When the tenon template 52B is connected to the template support 54, the axis of rotation of the cutting guide 50 is centered between the opposite end segments of the tenon template cutting edge 86B. As a result, the axis of rotation will extend through the center of the cut tenon T in the workpiece W. The cutting guide 50 is rotatable relative to the guide base 24 between the first and second cutting positions. The cutting guide 50 rotates about 180-degrees between the first and second cutting positions.

Referring back to FIGS. 5-9, the guide assembly 14 includes a cutting guide retainer 88 (broadly, retainer) for securing the cutting guide 50 in at least one of the different, rotational cutting positions (e.g., first cutting position, second cutting position, etc.) or orientations. In the illustrated embodiment, the cutting guide retainer 88 secures and holds the cutting guide 50 in each cutting position (e.g., the first cutting position and second cutting position). The cutting guide retainer retainer 88 is movable (e.g., longitudinally slideable) relative to the cutting guide 50 (and the guide base 24) between a retaining position (FIGS. 5, 6 and 9) in which the cutting guide retainer selectively engages the cutting guide 50 to inhibit the cutting guide from moving (e.g., rotating) relative to the guide base, and a release position in which the cutting guide retainer is disengaged from the cutting guide to permit the cutting guide to move (e.g., rotate) relative to the guide base. In the illustrated embodiment, the cutting guide retainer 88 includes a projection or pin 90 (detent) and the cutting guide 50 (specifically the template support 54, and more specifically the perimeter of the circular body 59) includes a plurality of retaining recesses 92 sized and shaped to receive the projection. In other embodiments, the template support can include a plurality of projections and the cutting guide retainer can include a retaining recess. Engagement between the pin 90 and the cutting guide 50 when the pin is in one of the retaining recesses 92 positions the cutting guide in the cutting position associated with that particular retaining recesses and inhibits the cutting guide from moving out of the associated cutting position. In the illustrated embodiment, the pin 90 has a cylindrical shape and the retaining recesses 92 have half cylindrical shapes, although other shapes can be used without departing from the scope of the present disclosure.

In the illustrated embodiment, the cutting guide retainer 88 includes a slide block or body 94 underlying the guide base 24. The slide block 94 is elongate and disposed within an elongate recess 95 in the platform 22 and cooperating elongate recess 96 in the bottom surface of the guide base 24. The slide block 94 is movable forward and rearward, parallel to the travel axis TA, in the elongate recesses 95, 96 for moving the cutting guide retainer 88 between the retaining and release positions. A fastener 97 connects the slide block 94 to the guide base 24. The fastener 97 extends through a slot in the guide base 24, the slot being countersunk to accommodate the head of the fastener so the head of the fastener is flush with or recessed in the tool support surface 25 of the guide base to not interfere with the movement of the router base 3 over the tool support surface. The pin 90 is attached to the slide block 94, adjacent one end thereof for conjoint movement with the slide block. The cutting guide retainer 88 also includes a securing actuator 98 for securing the cutting guide retainer 88 in at least one of the retaining position or the release position, preferably both. In the illustrated embodiment, the securing actuator 98 comprises a threaded shaft 100, a washer 102, and a knob 104 threadably connected to the threaded shaft. The threaded shaft 100 extends upward though a slot in the guide base 24. The user tightens the knob 104 against the guide base 24 to secure (e.g., fix) the cutting guide retainer 88 in the retaining position and/or release position. Loosening the knob 104 from the guide base 24 permits the cutting guide retainer 88 to move between the retaining position and the release position. Other configurations of the cutting guide retainer can be used without departing from the scope of the present disclosure. For example, a biasing member such as spring can be incorporated to bias the cutting guide retainer toward one of the retaining position and release position.

With reference to FIGS. 14A and 14B, to cut the tenon T in the workpiece W, the jig 10 is configured in the tenon configuration by connecting the tenon template 52B to the template support 54. The user positions the workpiece W and the cutting window 84B (broadly, tenon template, more broadly, guide assembly 14) relative to one another so that the tenon T will be cut at the desired location. The user secures the workpiece against the front face 18 of the fence 16 with the clamp 6. The user may also move the guide assembly 14 in the forward direction D2 or rearward direction D1 to move the cutting window 84B relative to the workpeice W. The user positions the cutting guide 50 in the first cutting position and moves the cutting guide retainer 88 to the retaining position to secure the cutting guide 50 in the first cutting position. The user can then begin to cut the tenon T by inserting the bushing 4 of the router 1 into the cutting window 84B (with the support base 3 of the router resting on one or more of the tool support surfaces 25, 55, 82). After, the user can operate the router 1 to rotate the cutting element 2 and move the cutting element downward through the bushing 4 and into the workpiece W to begin cutting the tenon T (e.g., begin the first cut). The user moves the router 1 within the cutting window 84B to cut the tenon T. For example, the user keeps the bushing 4 in engagement with the tenon template cutting edge 86B and slides the bushing along the tenon template cutting edge to trace the perimeter of the cutting window 84B. The user may also trace other portions of the perimeter of the cutting window 84B, such as by keeping keep the bushing 4 in engagement with the exposed edges 80A of the key portion 80 and sliding the bushing along the exposed edges. The user may also move the router 1 in other ways such as back-and-forth and/or side-to-side in the cutting window 84B to cut the tenon T in the workpiece W. After the user has moved the cutting element 2 along the tenon template cutting edge 86B (and over other areas of the cutting window 84B to remove the desired material from the workpiece), the user withdraws the cutting element from the cutting window. After, the user moves the cutting guide retainer 88 to the release position, rotates the cutting guide 50 180-degrees to the second cutting position, and moves the cutting guide retainer back to the retaining position. With the cutting guide 50 in the second cutting position, the user operates the router 1 during a second cut in the same manner as the first cut (e.g., keeping the bushing 4 in engagement with the tenon template cutting edge 86B and sliding the bushing along the tenon template cutting edge) to cut the remaining portion of the tenon T in the workpiece. After the user has moved the cutting element 2 along the tenon template cutting edge 86B (and over other areas of the cutting window 84B to remove the desired material from the workpiece), the user withdraws the cutting element from the cutting window, thereby leaving the finished tenon T in the workpiece W.

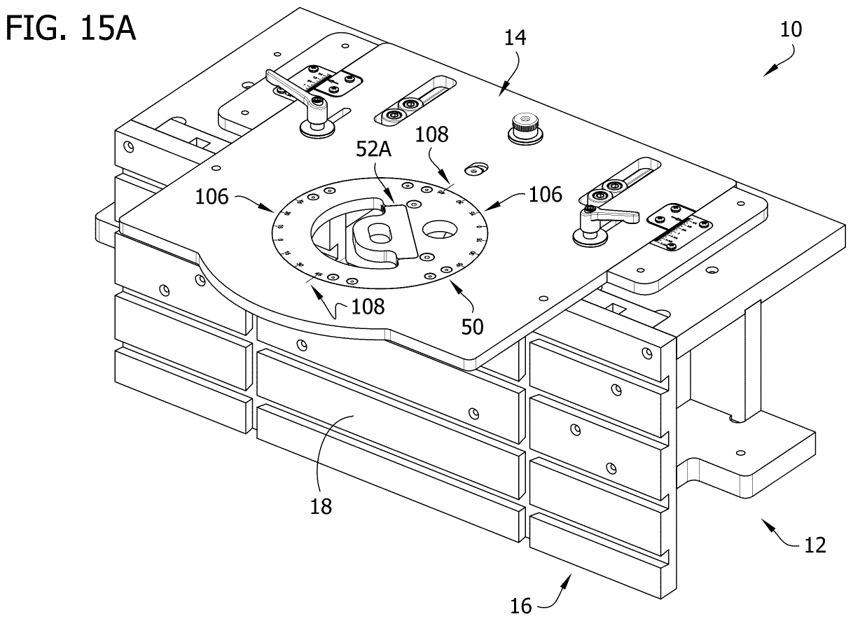

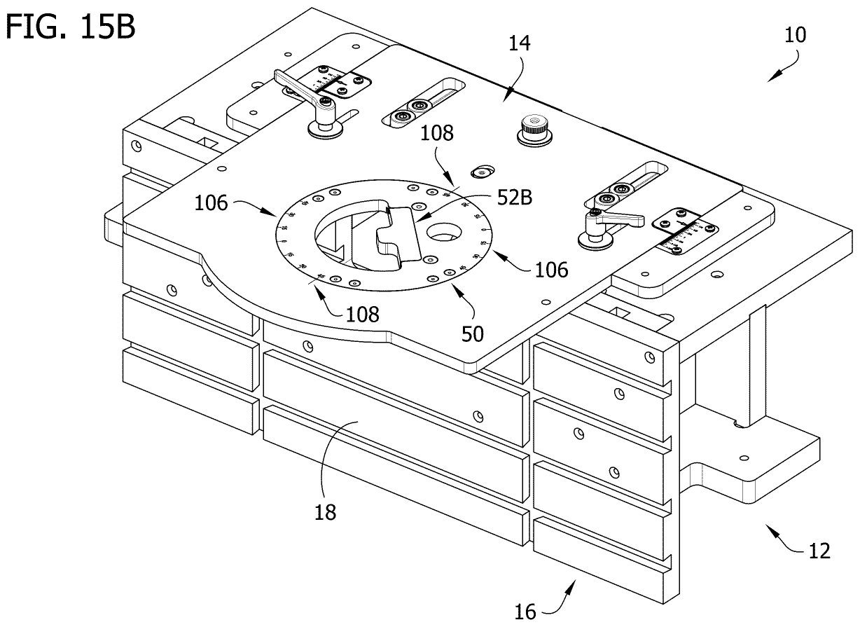

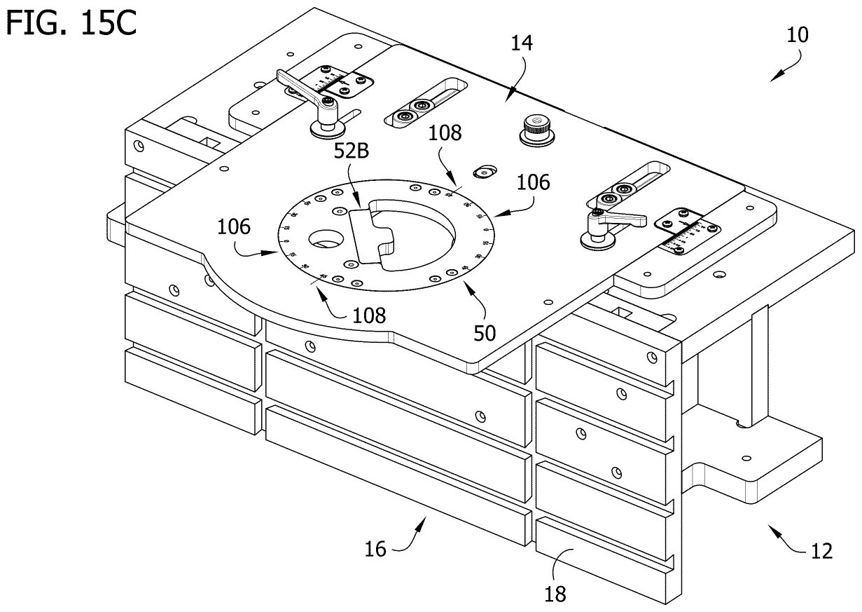

Referring to FIGS. 15A-C, the rotatability of cutting guide 50 relative to the guide base 24 also allows the orientation of the template 52A, 52B to be changed relative to the front face 18 (e.g., reference plane) of the fence 16 to change the orientation of the tenon T and/or mortise M cut in the workpiece W. Typically, as shown in FIGS. 3 and 14B, the tenon T and mortise M are cut in the workpiece W so that the length of the tenon and the length of the mortise is parallel to the reference plane (e.g., parallel to the surface of the workpiece pressed against the front face 18 of the fence). The rotatability of the cutting guide 50 allows the user, as desired, to configure the jig 10 to form an angled tenon and/or mortise in the workpiece (e.g., a tenon and/or mortise whose length extends at a non-parallel angle to the reference plane).

When using the guide assembly 14 to cut angled tenons and/or mortises, the cutting guide retainer 88 still secures the cutting guide 50 in place relative to the guide base 24. The cutting guide retainer 88 inhibits the cutting guide 50 from rotating relative to the guide base 24 to secure the orientation of the cutting guide (specifically the template 52A, 52B) relative to the workpiece W. The cutting guide 50 is free to rotate 360-degrees in either direction about the axis of rotation. The guide assembly 14 has a plurality of preset orientations (e.g., cutting orientations) the cutting guide 50 is rotatable to. The cutting guide retainer 88 is able to inhibit the cutting guide 50 from rotating regardless of which preset orientation of the plurality of preset orientations the cutting guide is in. In particular, the cutting guide retainer 88 allows the cutting guide 50 to be rotated in precise increments (e.g., 15-degree increments) between the discrete preset orientations. As shown in FIG. 11, the template support 54 includes a plurality of the retaining recesses 92 along spaced apart along the perimeter of the circular body 59. Each retaining recess corresponds to a cutting orientation or position of the cutting guide 50. The retaining recesses 92 are arranged in a first group 92A and a second group 92B. The first and second groups 92A, 92B are on generally opposite sides of the template support 54. The retaining recess 92 in the two groups 92A, 92B are arranged in pairs (one in each group), with each retaining recess 92 in the first group 92A having a corresponding retaining recess 92 in the second group 92B located directly opposite (e.g., 180-degrees apart) of it. The two retaining recesses 92 in each pair correspond to the first and second cutting positions for the tenon template 52B for cutting the tenon T in the workpiece, as described above.

In the illustrated embodiment, each group 92A, 92B includes seven retaining recesses 92, corresponding to seven discrete cutting orientations, although more or fewer retaining recesses (and thereby more or fewer cutting orientations) can be used without departing from the scope of the present disclosure. The seven cutting orientations include a 0-degree cutting orientation (the length of the tenon or mortise will be parallel to the reference plane), a plus 15-degree cutting orientation and a minus 15-degree cutting orientation (the length of the tenon or mortise will be plus/minus 15-degrees relative to the reference plane), a plus 30-degree cutting orientation and a minus 30-degree cutting orientation (the length of the tenon or mortise will be plus/minus 30-degrees relative to the reference plane), and a plus 45-degree cutting orientation and a minus 45-degree cutting orientation (the length of the tenon or mortise will be plus/minus 45-degrees relative to the reference plane). Other angles can be used without departing from the scope of the present disclosure.

The cutting guide 50 includes orientation (e.g., angle) indicia 106 (e.g., degree markings such as 0, 15, 30, and 45) for indicating the angle or cutting orientation of the cutting guide 50 relative to the reference plane. The guide base 24 includes one or two position indicators 108 (e.g., an arrow or a line) that align with one of the marks of the orientation indicia 106 for informing the user of the angle or orientation of the cutting guide 50 (specifically the template 52A, 52B) relative to the reference plane, and therefore the angle of the tenon or mortise that will be cut in the workpiece W. In the illustrated embodiment, each retaining recess 92 has its corresponding orientation indicia marking deposed directly above on the tool support surface 55 of the template support 54. When the user rotates the cutting guide 50 to align the desired orientation indicia marking with the position indicator 108 (e.g., a line), the retaining recess 92 associated with that orientation indicia marking will be in a position to receive the pin 90 of the cutting guide retainer 88, thereby securing the cutting guide 50 in the cutting orientation indicated by the orientation indicia marking. The orientation indicia 106 includes two sets, one for each group 92A, 92B of retaining recesses 92.

Referring to FIG. 15A, to cut an angled mortise, the user rotates the cutting guide 50 (with the cutting guide retainer 88 in the release position) until the desired marking of the orientation indicia 106 representative of the desired angle of the mortise aligns with the position indicator 108. The user then places the cutting guide retainer 88 in its retaining position, thereby securing the cutting guide 50 (e.g., the mortise template 52A) in the selected cutting orientation. In FIG. 15A, the cutting guide 50 has been rotated to the plus 45-degree cutting orientation (plus indicating the cutting guide was rotated in the clockwise direction about the axis of rotation from 0-degrees to be in that cutting orientation). For cutting the mortise, it does not matter which set of orientation indicia 106 the user uses (e.g., the set of orientation indicia associated with the first group 92A of retaining recesses 92 or the set of orientation indicia associated with the second group 92B of retaining recesses), as the mortise will be cut at the same angle relative to the reference plane regardless of which set is used. In the illustrated embodiment with two position indicators 108, each position indicator will align with the same value of orientation indicia marking for each set of orientation indicia 106.

Referring to FIGS. 15B and 15C, to cut an angled tenon, the user rotates the cutting guide 50 (with the cutting guide retainer 88 in the release position) until the desired orientation indicia marking of one set of orientation indicia 106 representative of the desired angle of the tenon aligns with the position indicator 108. The user then places the cutting guide retainer 88 in its retaining position, thereby securing the cutting guide 50 (e.g., the tenon template 52B) in the selected cutting orientation. In FIG. 15B, the cutting guide 50 has been rotated to the plus 45-degree cutting orientation. The cutting guide 50 is now in the first cutting position for the selected cutting orientation. The user then uses the router 1 to make the first cut to cut the first portion of the tenon in the workpiece W. After, the user rotates the cutting guide 50 (with the cutting guide retainer 88 in the release position) 180-degrees until the same desired orientation indicia marking of the other set of orientation indicia 106 representative of the desired angle of the tenon aligns with the position indicator 108. This moves the other retaining recess 92 of the pair into alignment with the cutting guide retainer 88. The user then places the cutting guide retainer 88 in its retaining position, thereby securing the cutting guide 50 (e.g., the tenon template 52B) in the selected cutting orientation. The cutting guide 50 is now in the second cutting position for the selected cutting orientation. In FIG. 15C, the cutting guide 50 has been rotated to this second cutting position for the plus 45-degree cutting orientation. The user then uses the router 1 to make the second cut to cut the remainder of the tenon in the workpiece W.

For reference, FIG. 2 shows the cutting guide 50 with the mortise template 52A rotated to the 0-degree cutting orientation to cut the mortise M parallel to the reference plane. FIG. 14A shows the cutting guide 50 with the tenon template 52B rotated to the first cutting position for the 0-degree cutting orientation. FIG. 14B shows the cutting guide 50 with the tenon template 52B rotated to the second cutting position for the 0-degree cutting orientation.

It is appreciated that the person of ordinary skill in the art is readily able to determine the scope of terms of degree such as, but not limited to, “about,” “substantially,” and “generally.” For example, when a term of degree is used in relation to a numeric value (e.g., 90-degrees (e.g., perpendicular), 0-degrees (e.g., parallel), etc.), the person of ordinary skill in the art understands that the term of degree covers an inclusive range of plus or minus 10% (including the exact value) of the numeric value, including any specific value or sub-range within the inclusive range, unless clearly indicated or stated otherwise.

While particular elements, embodiments, and applications of the present disclosure have been shown and described, it is understood that the disclosure is not limited thereto because modifications may be made by those skilled in the art, particularly in light of the foregoing teaching. It is therefore contemplated by the appended claims to cover such modifications and incorporate those features which come within the spirit and scope of the disclosure.

Having described the present disclosure in detail, it will be apparent that modifications and variations are possible without departing from the scope of the present disclosure defined in the appended claims.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the present disclosure are achieved and other advantageous results attained.

As various changes could be made in the above constructions and methods without departing from the scope of the present disclosure, it is intended that all matter contained in the above description and shown in the accompanying drawings shall be interpreted as illustrative and not in a limiting sense.

What is clamed is:

1. A jig for cutting a tenon in a workpiece using a tool having a cutting element, the jig comprising:
a guide assembly configured to locate and guide the cutting element of the tool relative to the workpiece to cut the tenon in the workpiece, the guide assembly comprising:
a guide base; and
a guide supported by the guide base, the guide including a tenon template arranged to be engaged and followed by the tool to cut the tenon in the workpiece, the guide being movable relative to the guide base between a first cutting position in which the tenon template is arranged relative to the workpiece so that the tool cuts a portion of the tenon in the workpiece as the tool engages and follows the tenon template and a second cutting position in which the tenon template is arranged relative to the workpiece so that the tool cuts another portion of the tenon in the workpiece as the tool engages and follows the tenon template.

2. The jig of claim 1, wherein in the first cutting position the tenon template is arranged relative to the workpiece so that the tool cuts approximately half of the tenon in the workpiece as the tool engages and follows the tenon template, and wherein in the second cutting position the tenon template is arranged relative to the workpiece so that the tool cuts a remaining portion of the tenon in the workpiece.

3. The jig of claim 1, wherein the guide is slidably mounted on the guide base.

4. The jig of claim 1, wherein the guide is rotatable relative to the guide base between the first and second cutting positions.

5. The jig of claim 4, wherein the guide rotates about 180-degrees between the first and second cutting positions.

6. The jig of claim 1, wherein the retainer is configured to secure the guide in the first cutting position and the second cutting position.

7. The jig of claim 1, wherein the guide defines a cutting opening sized and shaped to permit the cutting element of the tool to be inserted through the cutting opening to cut the tenon in the workpiece.

8. The jig of claim 7, wherein the tenon template bounds at least a portion of the cutting opening.

9. The jig of claim 1, wherein the guide includes a tool support surface arranged to be engaged by and support the tool as the tool cuts the tenon in the workpiece.

10. A jig for cutting a tenon or a mortise in a workpiece using a tool having a cutting element, the jig comprising:
a guide assembly configured to locate and guide the cutting element of the tool relative to the workpiece to cut the tenon or the mortise in the workpiece, the guide assembly comprising:
a template support including a template connector;
a tenon template configured to be engaged and followed by the tool to cut the tenon in the workpiece, the tenon template being releasably connectable to the template connector to configure the jig for cutting the tenon in the workpiece; and
a mortise template configured to be engaged and followed by the tool to cut the mortise in the workpiece, the mortise template being releasably connectable to the template connector to configure the jig for cutting the mortise in the workpiece.

11. The jig of claim 10, wherein the tenon template includes a tenon template cutting edge shaped such that the cutting element cuts the tenon in the workpiece as the tool moves in engagement with and along the tenon template cutting edge when the tenon template is connected to the template connector of the template support.

12. The jig of claim 10, wherein the mortise template includes a mortise template cutting edge shaped such that the cutting element cuts the mortise in the workpiece as the tool moves in engagement with and along the mortise template cutting edge when the mortise template is connected to the template connector of the template support.

13. The jig of claim 10, wherein the template connector includes a recess sized and shaped to receive at least a portion of the tenon template when the tenon template is connected to the template connector and at least a portion of the mortise template when the mortise template is connected to the template connector.

14. The jig of claim 10, wherein the template connector includes a template retainer configured to secure the tenon template to the template connector when the tenon template is connected to the template connector and to secure the mortise template to the template connector when the mortise template is connected to the template connector.

15. The jig of claim 14, wherein the template retainer comprises at least one fastener.

16. The jig of claim 10, wherein the template support includes a first tool support surface arranged to be engaged by and support the tool as the tool cuts the workpiece, the tenon template including a tenon template tool support surface, the tenon template tool support surface arranged to be coplanar with the first tool support surface when the tenon template is connected to the template connector of the template support to also be engaged by and support the tool as the tool cuts the tenon in the workpiece, the mortise template including a mortise template tool support surface, the mortise template tool support surface arranged to be coplanar with the first tool support surface when the mortise template is connected to the template connector of the template support to also be engaged by and support the tool as the tool cuts the mortise in the workpiece.

17. The jig of claim 10, further comprising a guide base supporting the template support, the template support being rotatable relative to the guide base to change the orientation of the tenon template relative to the workpiece to change the orientation of the tenon cut in the workpiece when the tenon template is connected to the template connector of the template support and to change the orientation of the mortise template relative to the workpiece to change the orientation of the mortise cut in the workpiece when the mortise template is connected to the template connector of the template support.

18. The jig of claim 10, further comprising a guide base supporting the template support, the template support being rotatable relative to the guide base between a first cutting position in which when the tenon template is connected to the template connector the tenon template is arranged relative to the workpiece so that the tool cuts a portion of the tenon in the workpiece as the tool engages and follows the tenon template and a second cutting position in which when the tenon template is connected to the template connector the tenon template is arranged relative to the workpiece so that the tool cuts a portion of the tenon in the workpiece as the tool engages and follows the tenon template.

19. A jig for cutting a tenon or a mortise in a workpiece using a tool having a cutting element, the jig comprising:
a guide assembly configured to locate and guide the cutting element of the tool relative to the workpiece to cut the tenon or the mortise in the workpiece, the guide assembly comprising:
a guide base;
a guide supported by the guide base, the guide including a template arranged to be engaged and followed by the tool to cut the tenon or the mortise in the workpiece, the guide being rotatable relative to the guide base to change the orientation of the template relative to the workpiece to change the orientation of the tenon or the mortise cut in the workpiece; and
a retainer configured to selectively inhibit the guide from rotating relative to the guide base to secure the orientation of the template relative to the workpiece.

20. The jig of claim 19, wherein the guide is rotatable relative to the guide base to a plurality of preset orientations, the retainer configured to inhibit the guide from rotating relative to the guide base in each preset orientation of the plurality of preset orientations.
